(19) United States
(12) Patent Application Publication
(10) Pub. No.: US 2007/0294738 A1
(43) Pub. Date: Dec. 20, 2007

(54) Single chip cable set-top box supporting DOCSIS set-top Gateway (DSG) protocol and high definition advanced video codec (HD AVC) decode

(75) Inventors: Jonathan Huy Kuo, Aliso Viejo, CA (US); Hongchang Liang, Austin, TX (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Broadcom Corporation, Irvine, CA (US)

(21) Appl. No.: 11/808,510

(22) Filed: Jun. 11, 2007

Related U.S. Application Data
(60) Provisional application No. 60/814,040, filed on Jun. 16, 2006.

(51) Int. Cl. H04N 7/16; H04N 7/173

(52) U.S. Cl. 725/116; 725/114; 725/144; 725/146

(57) ABSTRACT

A single integrated circuit is provided to enable the distribution of voice, video, and/or data services throughout a multimedia distribution network, such as a cable communications network. The single integrated circuit supports both digital and analog television services (e.g., PVR, pay-for-view, EPG, e-commerce, etc.) and computer data services (e.g., telephony, Internet browsing, facsimile, messaging, videoconferencing, etc.). In an embodiment, the single integrated circuit includes three components that constitute a DOCSIS™ compliant cable modem, namely an inband demodulator, an upstream burst modulator, a media access controller, and a microprocessor. In an embodiment, a digital out-of-band demodulator is also included. In another embodiment, the single integrated circuit integrates front-end and backend set-top box functionality in addition to DOCSIS™ cable modem functionality.

### CROSS REFERENCE TO RELATED APPLICATIONS

This patent application claims the benefit of U.S. Provisional Patent Application No. 60/814,040, filed Jun. 16, 2006, entitled “Single Chip Set-top Box Supporting DOCSIS™ Set-top Gateway (DSG) Protocol and High Definition Advanced Video Codec (HD AVC) Decode,” which is incorporated herein by reference in its entirety.

### BACKGROUND OF THE INVENTION

1. Field of the Invention

The present invention relates generally to communications networking, and more specifically, to a cable set-top box supporting DOCSIS™ DSG Protocol and HD AVC decode within a communications network.

2. Related Art

In a communications network, such as cable service network, a communications device (such as a modem) requests bandwidth from a headend device prior to transmitting data to its destination. Thus, the headend device serves as a centralized point of control for allocating bandwidth to the communications devices.

A cable network headend typically includes a cable modem termination system (CMTS) which consists of a media access controller (MAC) and central processing unit (CPU). The MAC receives upstream signals from a transceiver that communicates with remotely located cable modems. The upstream signals are delivered to the CPU for protocol processing. The protocol processing is conventionally defined by the Data Over Cable Service Interface Specification (DOCSIS™) that governs cable communications. Depending on the nature of the protocol processing, the CPU must be able to handle these operations efficiently and timely so as to not impede performance. As more subscribers and/or services are added to the network, greater emphasis is placed on the MAC and CPU to sustain protocol processing with no interruption in service.

In the downstream, the cable modem typically includes a MAC and access to a CPU. To support the increasing demand for enhanced and interactive cable services, cable providers are beginning to deploy set-top boxes that include cable modem functionality. Set-top box systems with integrated cable modem functionality use two to three chips to implement the combined functions of a set-top, cable modem, and processor. This results in an increase of the overall cost, power requirement, and form factor (e.g., size) of the set-top box making it difficult for cable providers to deploy them to the mass market.

Therefore, a system is needed to decrease the overall cost, power requirement, and form factor (e.g., size) of the cable set-top box.

### BRIEF DESCRIPTION OF THE DRAWINGS/FIGURES

The present invention is described with reference to the accompanying drawings. In the drawings, like reference numbers indicate identical or functionally similar elements. Additionally, the left most digit(s) of a reference number identifies the drawing in which the reference number first appears.

FIG. 1 illustrates a DOCSIS™ DSG according to an embodiment of the present invention.

FIG. 2 illustrates a block diagram of a set-top device according to an embodiment of the present invention

FIG. 3A illustrates a block diagram of a cable front end according to an embodiment of the present invention.

FIG. 3B illustrates a more detailed block diagram of the cable front end according to an embodiment of the present invention.

FIG. 4A illustrates a block diagram of a video/audio backend according to an embodiment of the present invention.

FIG. 4B illustrates a more detailed block diagram of the video/audio backend according to an embodiment of the present invention.

FIG. 5 illustrates a block diagram of a processor according to an embodiment of the present invention.

### DETAILED DESCRIPTION OF THE INVENTION

The following detailed description of the present invention refers to the accompanying drawings that illustrate exemplary embodiments consistent with this invention. Other embodiments are possible, and modifications may be made to the embodiments within the spirit and scope of the invention. Therefore, the detailed description is not meant to limit the invention. Rather, the scope of the invention is defined by the appended claims.

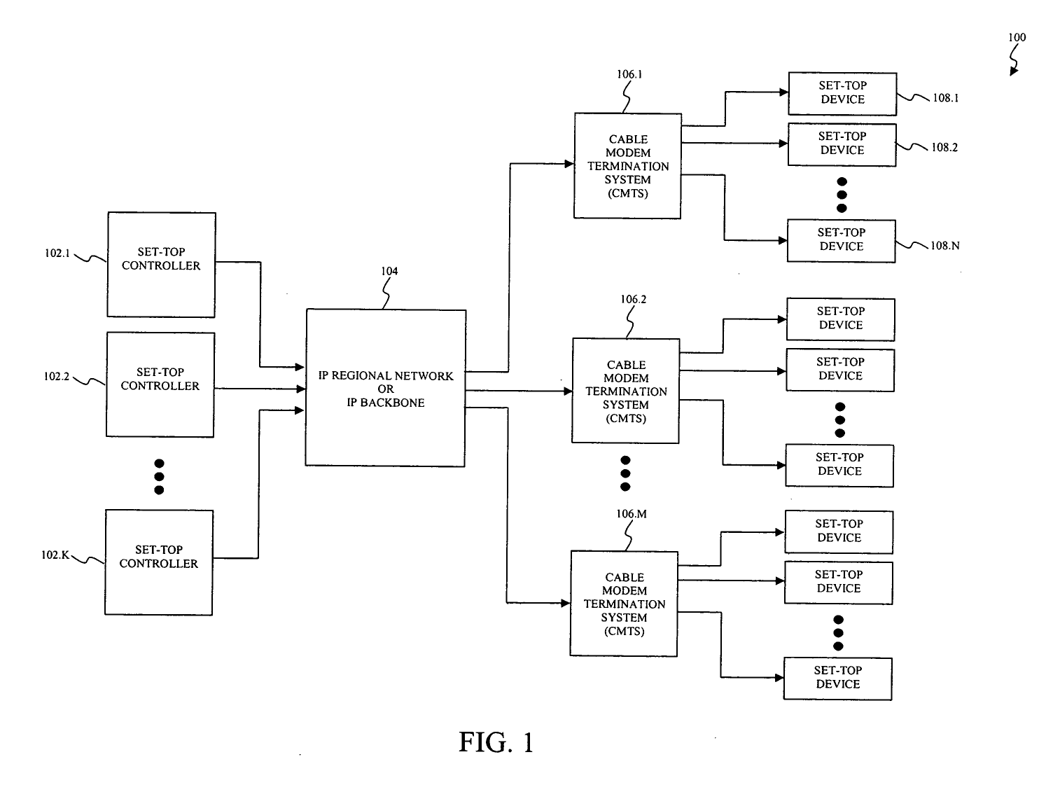

FIG. 1 illustrates a DOCSIS™ DSG according to an embodiment of the present invention. The DSG defines functionality on a DOCSIS™ CMTS and DOCSIS™ Cable Modem (CM) to support the configuration and transport of a class of service known as “Out-Of-Band (OOB) messaging” between a set-top controller (or application servers) and the customer premise equipment (CPE). OOB messaging refers to the control and information sent from the set-top controller (or Application Sever or similar device for legacy OOB messaging) to one or more set-top devices. Specifically, the OOB infers the use of a dedicated channel for signaling which is separate from a video channel. OOB messaging may include, but is not limited to, conditional access messages including entitlements, service information messages, electronic program guide messages, emergency alert system messages or other control or information messages which are readily apparent to those skilled n the art.

As shown in FIG. 1, a DSG 100 includes set-top controllers 102, an internet protocol (IP) network 104, cable modem termination systems (CMTS) 106, and set-top devices 108. The set-top controllers 102 are computer systems responsible for managing set-top devices, such as the set-top devices 108 to provide an example, within a cable system. In an exemplary embodiment, the set-top controllers 102 manage the set-top devices through control and information sent via an OOB channel. Those skilled in the art will recognize that the set-top controllers 102 may manage the set-top devices through control and information using any suitable information channel without departing from the spirit and scope of the present invention.

Referring back to FIG. 1, the set-top controller 102 comprises K set-top controllers 102.1 through 102.K. The set-top controllers 102.1 through 102.K may additionally include a DSG Server, such as an Application Server or other network attached device to provide some examples, to provide content through a DSG Tunnel to a DSG Client. The DSG client terminates the DSG tunnel and receives content from the DSG Server. The DSG tunnel refers to a stream of packets sent from a corresponding CMTS 106 to a corresponding set-top device.

The set-top controllers 102 connect to at least one CMTS 106 via the internet protocol (IP) network 104. The CMTS 106 comprises M set-top controllers 106.1 through 106.M. The CMTS 106 may additionally include a DSG Agent to implement the DSG protocol within a corresponding CMTS 106.1 through 106.M. The DSG Agent creates the DSG tunnel, places content from the DSG server into the DSG tunnel, and sends the DSG Tunnel to the DSG Client.

As shown in FIG. 1, each CMTS 106 connects to the set-top devices 108. The set-top devices 108 are cable receivers that include an embedded Cable Modem for DOCSIS™ connectivity and an embedded set-top box. The set-top devices 108 comprise N set-top devices 108.1 through 108.N. The set-top devices 108 may additionally include an embedded DOCSIS™ Cable Modem (eCM) that includes DSG functionality, the DSG Client(s), a DSG client controller, an embedded processor for an application environment, and either an embedded or removable module for conditional access. There may be more than one DSG Client within a set-top device. The DSG Client Controller handles processing of DCD messages and makes decisions regarding the forwarding of DSG Tunnels within the set-top device. Thus the OOB messages originate at the DSG Server, pass through the DSG Agent, onto the DSG tunnel, and termination at the DSG Client.

More information about the DSG 100 may be obtained from the DOCSIS™ set-top Gateway (DSG) Interface Specification, CM-SP-DSG-110-070223, Feb. 23, 2007, Cable Television Laboratories, Inc., which is incorporated by reference in its entirety.

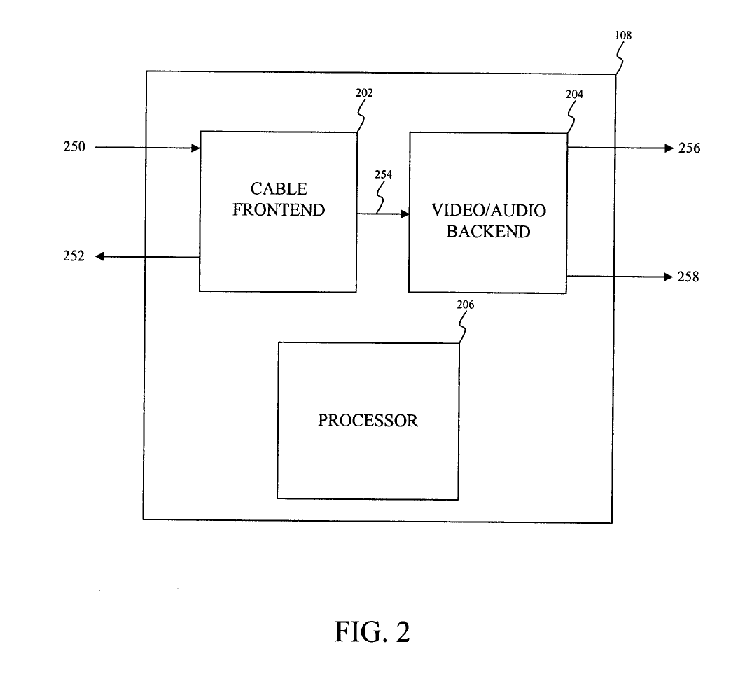

FIG. 2 illustrates a block diagram of a set-top device according to an embodiment of the present invention. The set-top device 108 is a cable set-top box solution that may include HD AVC (H.264/MPEG-4 Part 10, MPEG-2, and VC-1) video decoding technology. In an exemplary embodiment, the set-top device 108 further includes a data transport processor, a high-definition AVC/MPEG-2/VC-1 video decoder, an audio decoder, 2D graphics processing, video scaling, six video digital to analog converters (DACs), stereo high-fidelity audio DACs, a MIPS®32™/16-e class CPU, and a peripheral control unit providing a variety of set-top box control functions. The set-top device 108 may also include a DOCSIS™® 2.0+ subsystem combining dual-inband PHYs, an upstream PHY, an Ethernet MAC/PHY, an OOB MAC/PHY, and a dual-thread MIPS®32.

As shown in FIG. 2, the set-top device 108 includes a cable front end 202, a video/audio backend 204, and a processor 206. In an exemplary embodiment, the cable front end 202, the video/audio backend 204, and the processor 206 are fabricated on a single chip or die. Those skilled in the art will recognize that the cable front end 202, the video/audio backend 204, and the processor 206 may be fabricated on multiple chips or dies without departing from the spirit and scope of the present invention. The cable front end 202 transmits and receives signals from a corresponding CMTS 106.1 through 106.M. In embodiments, the underlying information signals are recovered from analog frequency signals received from the downstream. The information signals are converted from analog to digital form.

The cable front end 202 receives a downstream data signal 250 from the downstream traffic of a corresponding CMTS 106.1 through 106.M. In an exemplary embodiment, the downstream data signal 250 includes a video component and an audio component. In another exemplary embodiment, a tuner (not shown) receives a modulated version of the downstream data signal 250 from the corresponding CMTS 106.1 through 106.M and passes the downstream data signal 250 to the cable front end 202. In another exemplary embodiment, the downstream data signal 250 includes spectral characteristics in the frequency range of approximately 36-44 MHz or the broadband analog frequency range. The cable front end 202 may additionally include a programmable gain amplifier (PGA) and an analog to digital converter to amplify and/or digitize the downstream data signal 250. More specifically, after recovering the underlying information signals from the downstream data signal 250, the cable front end 202 supplies the information signals to an analog-to-digital (A/D) converter (not shown). The A/D converter converts the underlying information signals from an analog form to digital form that includes network frames or packets of data. In an exemplary embodiment, such frames are formatted in accordance with an MPEG or MPEG-2 format. However, it should be noted that other coding formats are supported.

The cable front end 202 may further include one or more demodulators, such as a quadrature amplitude modulation (QAM) demodulator to provide an example, to demodulate the downstream data signal 250 and one or more matched filters to filter the downstream data signal 250 to remove multipath propagation effects and narrowband co-channel interference. An integrated forward error correction device, such an integrated Reed-Solomon decoder, may be used by the cable front end 202 to perform error correction. A demodulated data stream 254 is delivered to the video/audio backend 254. In an exemplary embodiment, the demodulated data stream 254 is in either parallel or serial MPEG-2 transport format.

Conversely, the cable front end 202 accesses information signals intended for the upstream, and converts the signals from digital to analog form. The analog signals are upconverted into a frequency signal to produce an upstream data signal 252 in the appropriate range and transmitted in an appropriate upstream channel.

The video/audio backend 204 supports upstream and downstream processing, and enables the distribution of voice, video, and data services to the subscriber or other end-users. The video/audio backend 204 also interacts with hardware and software portions of various network protocols. In an exemplary embodiment, the video/audio backend 204 extracts voice, data, control messages, and/or the like, and supports methodologies and/or techniques for fragmentation, concatenation, cryptography, payload header suppression/expansion, and/or error checking for signals transported over the physical layer. In another embodiment, the video/audio backend 204 operates to process incoming and outgoing digital data in accordance with the DOCSIS 2.0+ specification. However, the video/audio backend 204 can be configured to support other protocol processes defined by the CableLabs® Certified™ Cable Modem project. For example, the video/audio backend 204, in an embodiment, includes an OpenCable™ compliant Point of Development interface as defined by the CableLabs® Certified™ Cable Modem project

Although the video/audio backend 204 is described with reference to DOCSIS™ protocol processing, it should be understood that the present invention is intended to be inclusive of other types of communication protocols governing multimedia distribution networks. For example, in an exemplary embodiment, the video/audio backend 204 performs protocol processing defined by the Digital Audio-Video Council (DAVIC).

The video/audio backend 204 may parse and/or deliver audio, video, and/or graphics data for digital television (also referred to herein as “cable television (CATV) programming data”) to an end user. The video/audio backend 204 may support, but is not limited to, audio and video decoding, two-dimensional and three-dimensional graphics processing, and mixed signal integration. In an embodiment, the video/audio backend 204 demultiplexes audio, video, and/or graphics from the downstream digital signals received from the cable front end 202. The video/audio backend 204 also supports the enhanced, personal, and/or interactive television functionalities of the present invention.

In an exemplary embodiment, the video/audio backend 204 accepts decoded AVC/MPEG/VC-1 or analog video and performs compositing of text and graphics with video. More specifically, the video data passes to the video processing stage where any scaling may be applied and the resulting video may be stored to memory for later display. During this video processing, any graphics or additional video may be combined just before being displayed. Graphics data can include station logos, chroma-keyer data, or the like, that is superimposed over video, and displayed on a television, monitor, PDA, portable computer, enhanced telephone, or the like. This architecture allows users to create a series of frame-buffers that allow an unlimited number of graphics layers to be composited and blended together before being displayed. Once the graphical frame-buffers are available, they may be combined with the video using a compositor. This compositor allows one video surface to be combined with a graphical surface (frame-buffers). The blending order of any surface is controlled by software to allow the utmost flexibility for the end-user. The graphic surface generation is now divorced from the real-time display requirements of the video output. Once the new graphics surface is available, it may be switched in for display. The manipulated video is then sent to the VEC(s) for display through the analog DAC outputs.

The processor 206 incorporates a microprocessor subsystem, including caches with bridging to memory and a local bus. In an exemplary embodiment, the processor 206 incorporates a complete MIPS®32™-based microprocessor subsystem. The processor 206 interacts with the cable front end 202 and the video/audio backend 204 to support digital television processing, including, but not limited to, enhanced, personal, and/or interactive television. The processor 206 may receive control messages from a user input interface (not shown), such as a remote control unit, keyboard, pointing device, mouse, mouse wheel, joystick, rudder pedals, touch screen, microphone, stylus, light pen, voice recognition unit, or the like. The processor 206 provides control messages to the cable front end 202 to select a downstream channel for receiving analog frequency signals. The processor 206 further provides control messages to the video/audio backend 204 to support requests for video, audio, and/or graphics data. The processor 206 may also support personal video recording to internal or external memories. In an embodiment, the processor 206 includes or enables access to Advanced Technology Attachment (ATA) (formerly known as Integrated Drive Electronics (IDE)) controllers for connection to disc drives.

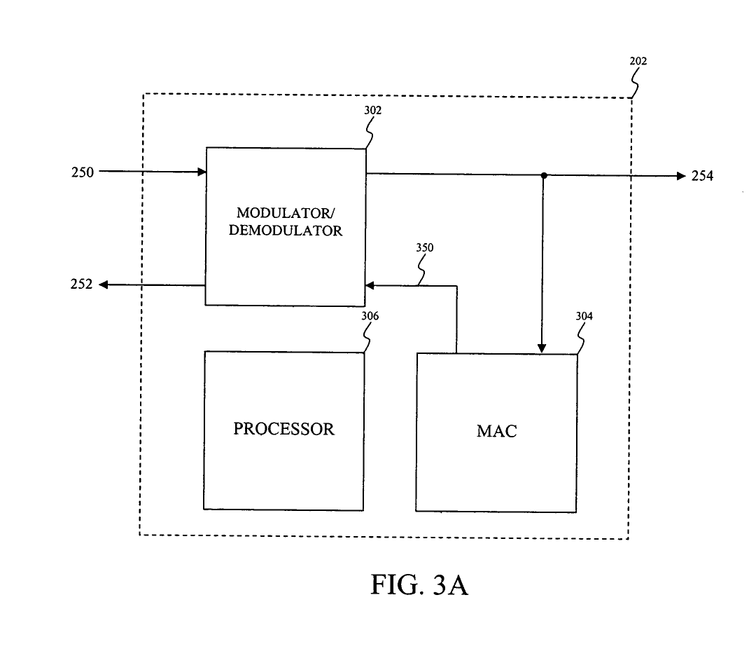

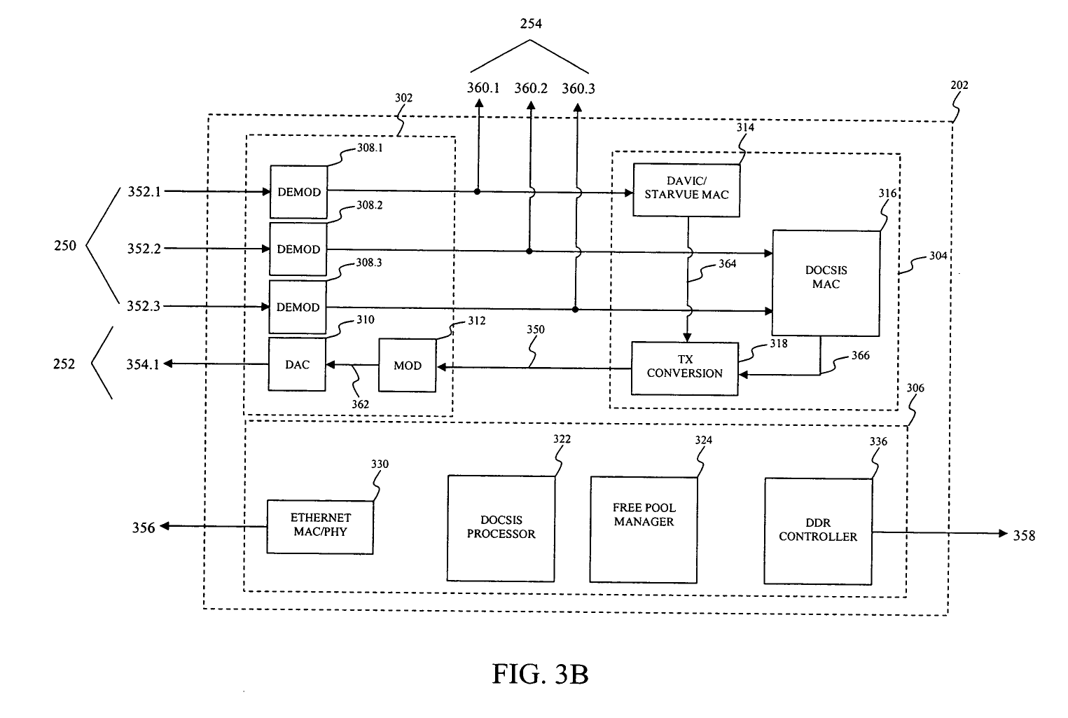

FIG. 3A illustrates a block diagram of a cable front end according to an embodiment of the present invention. As shown in FIG. 3A, the cable front end 202 includes a modulator/demodulator 302, a media access controller (MAC) 304, and a processor 306.

The modulator/demodulator 302 includes one or more downstream converters to downconvert or demodulate the downstream data signal 250 to produce the demodulated data stream 254. The modulator/demodulator 302 receives the downstream data signal 250, amplifies and digitizes the downstream data signal 250 with a programmable gain amplifier (PGA) and analog to digital (A/D) converter. The digital receiver may additionally demodulate, matched filter, and then adaptively filter the downstream data signal 250 to remove multipath propagation effects and narrowband co-channel interference. In an exemplary embodiment, all clock, carrier, gain acquisition, and tracking loops for the modulator/demodulator 302 are integrated on-chip as are the necessary phase-locked loops, referenced to a single external crystal.

The media access controller (MAC) 304 is DOCSIS™ compliant. The MAC 304 supports quality of service for broadband interactive services, such as VoIP and videoconferencing. In an exemplary embodiment, the cable set-top device 108 includes a dual tuner (not shown) that allows simultaneous viewing of either Internet and video (e.g., television video frames), two independent program streams for watching and recording (e.g. PVR, VCR, RW CD/DVD, etc.), or two independent program streams for picture-in-picture (PIP) functionalities. In an exemplary embodiment, the cable set-top device 108 allows any combination of “true” watch-and-record, PIP, and DOCSIS™ Internet browsing simultaneously. In an exemplary embodiment, the cable set-top device 108 allows any combination of watch-and-record, PIP, DOCSIS™ protocol processing, and DAVIC protocol processing all simultaneously.

For upstream communications, the MAC 304 prepares and formats DOCSIS™ upstream data, voice packets, control messages, or the like. In an exemplary embodiment, the MAC 304 interacts with the processor 206 to permit CATV control messages to be sent upstream to a corresponding CMTS 106.1 through 106.M for delivery to a transmitter or server for a broadcaster or other service provider. The CATV control messages from the processor 206 are integrated with the DOCSIS™ information (e.g., voice, data, control, etc.), and forwarded to the cable frontend 202.

The MAC 304 may additionally include baseline privacy encryption and decryption, a transmission convergence sublayer support, a TDM/TDMA framer, and a scatter/gather DMA interface. The transmission convergence sublayer supports frame acquisition and multiplexing. The TDM/TDMA framer handles time synchronization with a corresponding CMTS 106.1 through 106.M, upstream MAP decoding, bandwidth request generation, and contention resolution. The DMA mechanism supports descriptor based scatter/gather operations to and from shared memory through an internal system bus (ISB). The MAC 304 logic includes downstream functions, upstream functions, DMA interface, and miscellaneous control. A downstream processor, a message processor, and a downstream DES section of the MAC 304 perform the downstream functions. A MAP processor, an upstream DES, and an upstream processor section of the MAC 304 perform the upstream functions. The DMA controllers handle accesses to and from system memory. The remaining sections of the MAC 304 may include a statistics (MIB) counters to provide miscellaneous control functions.

The processor 306 is a DOCSIS™ compliant processor to provide the necessary control for the modulator/demodulator 302 and/or the MAC 304. In an exemplary embodiment, the processor 306 is implemented using an MIPS® processor core. The processor 306 may additionally include read ahead cache and dedicated low-latency access port to a memory storage device, such as a DRAM to provide an example. The processor 306 may further include one or more single cycle multiply and accumulate engines as well as a channel memory-to-memory DMA controller.

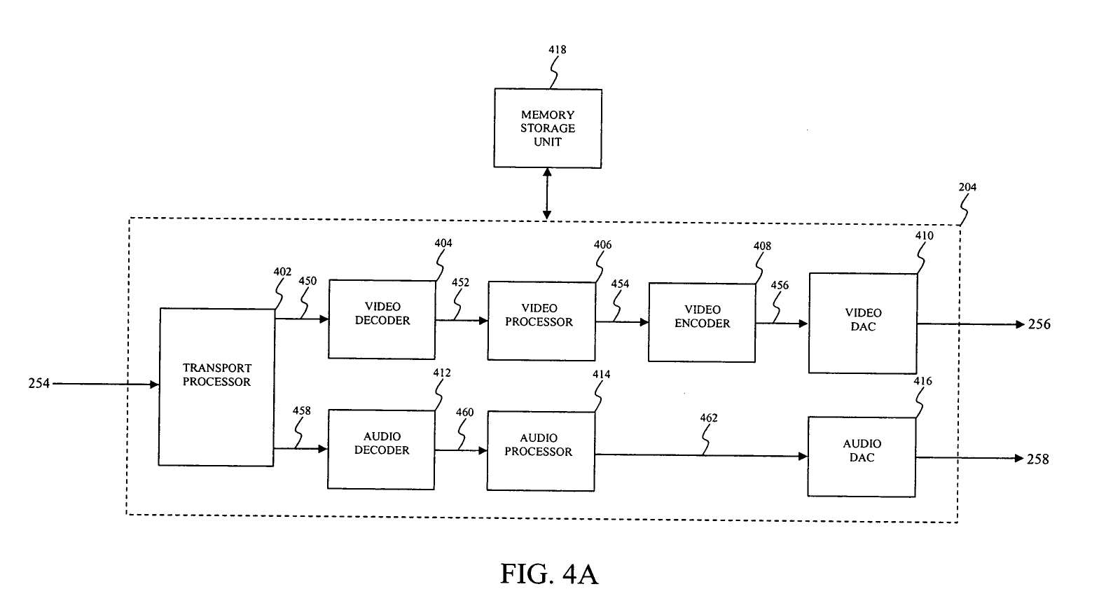

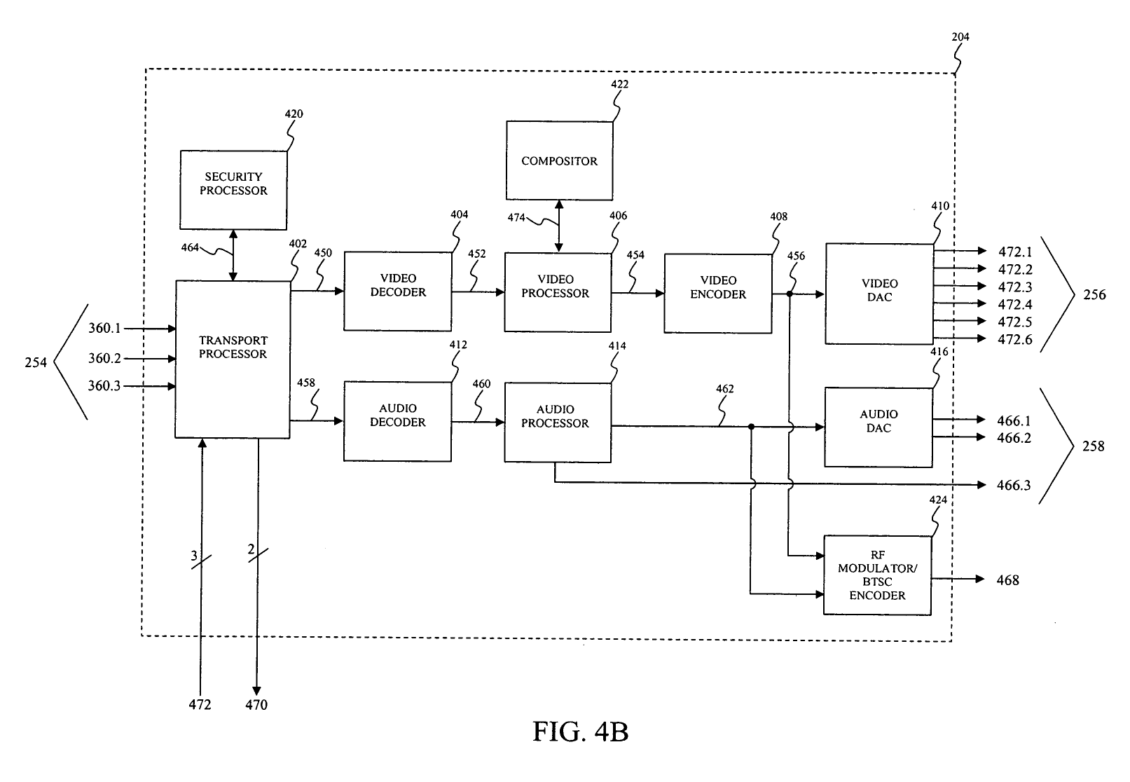

FIG. 3B illustrates a more detailed block diagram of the cable front end according to an embodiment of the present invention. As shown in FIG. 4B, the modulator/demodulator 302 includes demodulators 308.1 through 308.3, a digital to analog converter (DAC) 310 and a modulator 312.

The demodulators 308.1 through 308.3 may include at least one OOB demodulator, such as OOB Demod 308.1 in FIG. 3B, to support OOB messaging. As shown in FIG. 3B, the OOB Demod 308.1 receives then downconverts an OOB message 352.1 to produce a demodulated data stream 360.1. The OOB message 352.1 may include, but is not limited to, conditional access messages including entitlements, service information messages, electronic program guide messages, emergency alert system messages, or other control or information messages that are readily apparent to those skilled in the art. In an exemplary embodiment, the OOB Demod 308.1 is implemented as a Quadrature Phase Shift Keyed (QPSK) receiver. In another exemplary embodiment, the OOB Demod 308.1 comprises a frequency agile oscillator that downconverts any channel in the 70-130 MHz frequency range to a surface acoustic wave (SAW)-centered intermediate frequency (IF) output. In a further exemplary embodiment, OOB demodulator 604 receives signals within the frequency range of approximately 100-200 MHz LO. The OOB Demod 308.1 may support gigabit media independent interface (GMII interface) networks and forwards data to the video/audio backend 204.

The OOB Demod 308.1 may includes a programmable gain amplifier (PGA) and an analog to digital (A/D) converter, a demodulator, an adaptive equalizer, synchronization loops, and an FEC decoder. In an exemplary embodiment, the OOB Demod 308.1 additionally includes is used with an IF centered signal. The OOB Demod 308.1 uses a frequency agile local oscillator to down convert a channel to an IF centered signal. In an exemplary embodiment, the OOB Demod 308.1 down converts any channel in the 70-130 MHz frequency range to a SAW centered IF. The A/D converter sub-samples the down converted channel at a rate that is more than the sample rate, such as 8x the symbol rate to provide an example. The OOB Demod 308.1 receives the sub-sampled input from the A/D converter and down converts it to baseband. The resulting baseband data stream is resampled under the control of the clock recovery loop to produce a data stream that is correctly sampled in both frequency and phase. Nyquist filters then filter the baseband data stream.

The OOB Demod 308.1 may additionally include a decision feedback equalizer (DFE) to remove the intersymbol interference (ISI) generated by coaxial cable channels including a wide variety of impairments such as unterminated stubs to provide an example. The OOB Demod 308.1 may further include a frame synchronizer, a deinterleaver, a Reed-Solomon decoder and a derandomizer to perform forward error correction (FEC). In an exemplary embodiment, the FEC is programmable to handle both the DigiCipher II and DAVIC out-of-band FEC specifications.

The OOB Demod 308.1 may further include one or more automatic gain control (AGC) loops. Each of the AGC loops includes a power estimate, a threshold comparison, and a loop filter. The OOB Demod 308.1 may additionally include a baud recovery loop having a timing error discriminant, a loop filter, and a digital timing recovery block that controls a digital resampler. The timing error discriminant outputs a new value each baud that is filtered by a digital integral-plus proportional lowpass filter, which features programmable coefficients. The loop integrator may be read for loop monitoring or written for direct control. The upper bits of the loop filter are applied to a digitally controlled frequency synthesizer. The OOB Demod 308.1 may also include a carrier frequency/phase recovery and tracking loops. The loops use a decision directed phase discriminant to estimate the angle and direction for frequency/phase compensation. The output of the loop filter is used to control a complex derotator to provide for frequency/phase compensation.

Referring back to FIG. 3B, the demodulators 308.1 through 308.3 may additionally include at least one in-band demodulator such as the demod 308.2 and/or the demod 308.3 in FIG. 3B. As shown in FIG. 3B, the demod 308.2 receives then downconverts an inband data stream 352.2 to produce a demodulated data stream 360.2. Similarly, the demod 308.3 receives then downconverts an inband data stream 352.3 to produce a demodulated data stream 360. In an exemplary embodiment, a tuner (not shown) receives modulated analog signals from a corresponding CMTS 106.1 through 106.M and passes the appropriate frequencies to demod 308.2 and/or demod 308.3. In another exemplary embodiment, the analog signals include spectral characteristics in the frequency range of approximately 36-44 MHz or the broadband analog frequency range. In a further exemplary embodiment, the inband data stream 352 are analog signals centered at the standard television IF frequencies.

The demod 308.2 and/or the demod 308.3 may be implemented as a quadrature amplitude modulation (QAM) demodulator. In an exemplary embodiment, the demod 308.2 and/or the demod 308.3 supports 4/16/32/64/128/256/512/1024-QAM modulation technique to recover the underlying information signals from a corresponding inband data stream 352. After recovering, amplifying and digitizing this signal with an integrated programmable gain amplifier (PGA) and a A/D converter, the demod 308.2 and/or the demod 308.3 demodulates, matched filters, and then adaptively filters the signal to remove multipath propagation effects and narrowband co-channel interference. The A/D converter converts the underlying information signals from an analog form to digital form that includes network frames or packets of data. In an exemplary embodiment, such frames are formatted in accordance with an MPEG or MPEG-2 format. However, other coding formats are supported. The demod 308.2 and/or the demod 308.3 may additionally include integrated trellis and Reed-Solomon decoders to implement various coding formats, such as the ITU-T J.83 Annex A/B/C coding formats, to perform error correction.

An upstream burst modulator 312 transmits frequency signals carrying upstream data. The upstream burst modulator 312 receives digital signals 350 from the MAC 304 to produce a digital modulated upstream data stream 362. The upstream burst modulator 312 is a physical layer transmitter and is intended to transmit upstream data for DOCSIS™ applications. It incorporates an all-digital QAM modulator, a phase locked loop (PLL), and a power DAC with output power control. The upstream burst modulator 312 takes modulation symbols, pre-equalizes, filters, and modulates the data stream, and provides an analog output.

The upstream burst modulator 312 may include a pre-equalizer, square-root Nyquist pulse shaping filters, variable interpolation filters, a quadrature modulator, a digital scaler and an interpolation filter. The pre-equalizer may be optionally enabled to predistort the transmitted waveform to combat the effects of ISI. The data burst is then shaped by means of the square-root Nyquist filters. The pulse-shaping filters are followed by variable interpolation filter banks that interpolate the data signal to the sample rate. The output of these filters is then modulated onto carriers by a digitally tunable frequency synthesizer. The output is a digital waveform carrying the data burst whose frequency spectrum is centered on the desired RF frequency. The resulting signal may be digitally scaled by a digital scaler. The digital scaler is followed by an interpolation filter that interpolates the data to output a digital modulated upstream data stream 362.

The digital to analog converter DAC 310 converts the digital modulated upstream data stream 362 into an analog modulated upstream data stream 354.1. The digital signals 350 are modulated into a carrier signal in accordance with either a Quadrature Phase Shift Key (QPSK) or 256 QAM modulation techniques. In an exemplary embodiment, the signal is transmitted within the frequency range of approximately 0-108 MHz.

Referring back to FIG. 4B, the MAC 304 includes a DAVIC/STARVUE MAC 314, a DOCSIS™ MAC 316, and a TX conversion module 318. The DAVIC/STARVUE MAC 314 may support, but is not limited to, out-of-band downstream functions, upstream functions, memory interface, to provide some examples. The DAVIC/STARVUE MAC 314 may parse the demodulated data stream 360.1. The DAVIC/STARVUE MAC 314 may additionally include an upstream controller to perform all upstream timing and synchronization from the downstream. The DAVIC/STARVUE MAC 314 may further include an IUDMA controller to handle accesses to and from a memory storage device 418. The DAVIC/STARVUE MAC 314 may additionally filter data, do the SAR, and US timing control for the OOB interactive channel. In an exemplary embodiment, the filtering and SAR may be bypassed in any combination. Bypassing the filtering will pass all downstream data to the memory storage device 418, while bypassing the SAR will make the interface between HW and firmware the ATM layer.

As shown in FIG. 4B, the DOCSIS™ MAC 316 is configured to received the demodulated data streams 360.2 and 360.3. The DOCSIS™ MAC 316 is DOCSIS™-compliant. The DOCSIS™ MAC 316 supports quality of service for broadband interactive services, such as VoIP and videoconferencing. In an exemplary embodiment, the cable set-top device 108 includes a dual tuner (not shown) that allows simultaneous viewing of either Internet and video (e.g., television video frames), two independent program streams for watching and recording (e.g. PVR, VCR, RW CD/DVD, etc.), or two independent program streams for picture-in-picture (PIP) functionalities. In an exemplary embodiment, the cable set-top device 108 allows any combination of “true” watch-and-record, PIP, and DOCSIS™ Internet browsing simultaneously. In an exemplary embodiment, the cable set-top device 108 allows any combination of watch-and-record, PIP, DOCSIS™ protocol processing, and DAVIC protocol processing all simultaneously.

The DOCSIS™ MAC 316 may additionally include baseline privacy encryption and decryption, a transmission convergence sublayer support, a TDM/TDMA framer, and a scatter/gather DMA interface. The transmission convergence sublayer supports frame acquisition and multiplexing. The TDM/TDMA framer handles time synchronization with a corresponding CMTS 106.1 through 106.M, upstream MAP decoding, bandwidth request generation, and contention resolution. The DMA mechanism supports descriptor based scatter/gather operations to and from shared memory through an internal system bus (ISB). The DOCSIS™ MAC 316 logic includes downstream functions, DMA interface, and miscellaneous control. A downstream processor, a message processor, and a downstream DES section of the DOCSIS™ MAC 316 perform the downstream functions. The DMA controllers handle accesses to and from system memory. The remaining sections of the DOCSIS™ MAC 316 may include a statistics (MIB) counters to provide miscellaneous control functions.

For upstream communications, the DAVIC/STARVUE MAC 314 over interface 364 and/or the DOCSIS™ MAC 316 over interface 366 prepares and formats DOCSIS™ upstream data, voice packets, control messages, or the like to be used by TX conversion module 318. In an exemplary embodiment, the DAVIC/STARVUE MAC 314 and/or the DOCSIS™ MAC 316 interacts with the processor 306 to permit CATV control messages to be sent upstream to a corresponding CMTS 106.1 through 106.M for delivery to a transmitter or server for a broadcaster or other service provider. The CATV control messages from the processor 306 are integrated with the DOCSIS™ information (e.g., voice, data, control, etc.), and forwarded to the modulator/demodulator 302.

As shown in FIG. 3B, the processor 306 includes a DOCSIS™ processor 322, a Free Pool Manager 324, an Ethernet MAC/PHY 330 and a DDR controller 336. The DOCSIS™ processor 322 is a DOCSIS™ compliant processor to provide the necessary control for the modulator/demodulator 302 and/or the MAC 304. In an exemplary embodiment, the DOCSIS™ processor 322 is implemented using an MIPS® processor core. The DOCSIS™ processor 322 may additionally include read ahead cache and dedicated low-latency access port to a memory storage device, such as a DRAM to provide an example.

The Free Pool Manager 324 contains a memory storage device, such as a SRAM to provide an example, mapped to memory space and control registers mapped to I/O space. In an exemplary embodiment, the Free Pool Manager 324 contains a 32 KB single-cycle SRAM mapped to memory space and control registers mapped to I/O space. In another exemplary embodiment, the Free Pool Manager 324 may include a FIFO which must be initialized in the SRAM; software reserves space in both the main memory and in the FIFO. The Free Pool Manager 324 includes a control register to specify the base offset of the area and size of the FIFO. The control register may contain an enable bit which enables or clears the contents of the FIFO. Each entry in the FIFO is a 16-bit pointer to a reserved block of memory that is used as a data buffer. Entries are added to the FIFO by writing to a FIFO Port register, or entries are removed by reading from the FIFO Port register. The read and write pointer of the FIFO may be read via the FIFO Pointer register. In an exemplary embodiment, when no buffers are in use, the FIFO is full, otherwise when all the buffers are in use, the FIFO goes empty. Counters may be provided for diagnostics of the Free Pool Manager 324. Both counters may be read and cleared via the FIFO Status register. The Free Pool Manager 324 may include an overflow counter to increment when an attempt is made to add an entry to a full FIFO and/or an underflow counter to increment when an attempt is made to read an entry from an empty FIFO.

The Ethernet MAC/PHY 330 provides physical media access through a media independent interface (MII) to either an internal 10/100 Ethernet transceiver or an external transceiver via an MII port 356. In addition to basic Ethernet access functions, the Ethernet MAC/PHY 330 provides statistic counters fully compliant with management information base (MIB) Statistics standards such as, but not limited to, RFC 1757, RFC 1643, or IEEE802.3 to provide some examples. The Ethernet MAC/PHY 330 may additionally provides control and protocol functions necessary for the transmission and reception of 802.3 data streams. During transmission, packet data is removed from a transmit FIFO, framed with preamble and CRC, and forwarded to the transceiver. During reception, the data is received from the transceiver, the frame's destination address and validity is checked, and packet data is placed into a receive FIFO.

The Ethernet MAC/PHY 330 may include an integrated Ethernet transceiver to perform all the physical layer interface functions for 100BASE-TX full-duplex or half-duplex Ethernet on CAT 5 twisted-pair cable and 10BASE-T full- or half-duplex Ethernet on CAT 3, 4, or 5 cable. The Ethernet Transceiver connects to the internal EMAC1 via the internal MII. The transceiver may perform, but is not limited to, 4B5B, MLT3, and Manchester encoding and decoding, clock and data recovery, stream cipher scrambling/descrambling, digital adaptive equalization, line transmission, carrier sense, and link integrity monitor, Auto-Negotiation, or management functions to provide some examples. The Ethernet Transceiver is compliant with the IEEE 802.3 and 802.3u or any other suitable standard.

The DDR controller 336 interfaces with a memory storage device, such as the memory storage device 418 using memory interface 358. The DDR controller 336 may include a DDR-1 controller. In an exemplary embodiment, the DDR controller 336 is implemented as a 16-bit DDR-1 (double-data rate) SDRAM memory controller supporting up to 256 MB of memory. The DDR controller 336 may additionally support 32-bit wide DDR for its memory interface. In an exemplary embodiment, the DRAM clock rate is 133 MHz. may support other on-chip clock rates, and externally supplied DRAM clocks may also be used. The DDR controller 336 may support, but is not limited to the following configurations: 4M×16 resulting in 8 MB, 8M×16 resulting in 16 MB, 16M×16 resulting in 32 MB, or 32M×16 resulting in 64 MB. The size of the memory storage device 418 will depend on the specific application.

FIG. 4A illustrates a block diagram of a video/audio backend according to an embodiment of the present invention. The video/audio backend 204 includes video and graphics processing, such as 2D graphics processing to provide an example, into the set-top device 108. As shown in FIG. 4A, the video/audio backend 204 includes a transport processor 402, a video decoder 404, a video processor 406, a video encoder 408, a video digital to analog converter (DAC) 410, an audio decoder 412, an audio processor 414, and an audio DAC 416.

The transport processor 402 receives the demodulated data stream 254 from the modulator/demodulator 302 and outputs a compressed video component 450 and a compressed audio component 458. More specifically, the transport processor 402 separates or parses the demodulated data stream 254 into the compressed video component 450 and the compressed audio component 458.

The video decoder 404 decodes the compressed video component 450 to produce an uncompressed video component 452. The video decoder 404 retrieves the compressed video component 450 placed into a memory storage device 418 by the transport processor 402, decodes the compressed video component 450, and writes the uncompressed video component 452 back to the memory storage for retrieval by the video processor 406. The memory storage device 418 may be implemented using as a Random Access Memory (RAM), a Dynamic RAM (DRAM), a Synchronous DRAM (SDRAM), a Double Data Rate SDRAM (DDR SDRAM), a hard disk drive, a flash drive such as a Universal Serial Bus (USB) flash drive, or any other suitable memory source capable of storing information. The memory storage device 418 may be located external to the video/audio backend 204 as shown in FIG. 4A or may be included in the video/audio backend 204. The video decoder 404 extracts the compressed video component 450 and index tables created by the data transport processor 402 from the memory storage device 418. The compressed video component 450 is decoded or decompressed and the resultant is stored back into the memory source unit 418.

The video processor 406 processes the uncompressed video component 452 to produce a processed video component 454. More specifically, the video processor 406 scales the uncompressed video component 452 in horizontal and vertical directions and either displays the video immediately (in-line) or captures the uncompressed video component 452 to the memory storage device 418 for later viewing.

The video encoder 408 encodes the processed video component 454 to produce an encoded video component 456. More specifically, the video encoder 408 encodes or formats the processed video component 454 into a well known analog video standard such as NTSC (all variations), PAL (all variations), 480i, 480p, or 576i to provide some examples. Those skilled in the art will recognize that the video encoder 408 may format the processed video component 454 into any other suitable video standard. In an exemplary embodiment, the encoded video component 456 is a standard definition television (SDTV) signal.

The video DAC 410 converts the encoded video component 456 from a digital representation to an analog representation to produce the analog video output 256.

The audio decoder 412 decodes the compressed audio component 458 to produce an uncompressed audio component 460. The audio decoder 412 decodes many compressed digital audio formats such as AAC+, AAC, MP3, MPEG, Dolby Digital Plus, and Dolby Digital to provide some examples. In an exemplary embodiment, the uncompressed audio component 460 is Pulse-code modulated (PCM).

The audio processor 414 processes the uncompressed audio component 460 to produce a processed audio component 462. The audio processor 414 may read PCM audio sound effects from the memory storage device 418. The audio processor 414 may combine or mix the uncompressed audio component 460 audio data with the PCM audio sound effects.

The audio DAC 416 converts the encoded audio component 462 from a digital representation to an analog representation to produce the analog audio output 258. More specifically, the audio DAC 416 converts the encoded audio component 462 from PCM data to an analog waveform. The audio DAC 416 may supports sample rates of, but not limited to, 32 kHz, 44.1 kHz, 48 kHz, and 96 kHz to provide some examples. Those skilled in the art will recognize that the audio DAC 416 may support may supports any suitable sample rate without departing from the spirit and scope of the present invention. In an exemplary embodiment, the analog audio output 258 is a pair of differential pulse density outputs for left and right channels that may be optionally low-pass filtered externally to recover the audio signal.

FIG. 4B illustrates a more detailed block diagram of the video/audio backend according to an embodiment of the present invention. As shown in FIG. 4B, the video/audio backend 204 includes the transport processor 402, the video decoder 404, the video processor 406, the video encoder 408, the video DAC 410, the audio decoder 412, the audio processor 414, and the audio DAC 416 as well as a security processor 420, a compositor 422, and a Radio Frequency (RF) Modulator/Broadcast Television Systems Committee (BTSC) encoder 424.

In the exemplary embodiment shown in FIG. 4B, the transport processor 402 is implemented as an MPEG-2 DVB-compliant transport stream message/PES parser and demultiplexer capable of simultaneously processing 256 Packet Identifications (PIDs) via 128 PID channels in up to three demodulated data streams 360.1 through 360.3 and two internal playback channels. In this exemplary embodiment, the transport processor 402 supports decryption for up to 128 PID channels in the demodulated data streams 360.1 through 360.3. All 128 PID channels may be used by an included record, audio, and video interface engine (RAVE), Program Clock Reference (PCR) processor, and/or message filter as well as for a remux/RAVE output 470 via the high-speed transport or remux module. The transport processor 402 RAVE may be configured to support up to eight record channels for personal video recording (PVR) functionality and up to six audio video (AV) channels to interface to audio and video decoders. The transport processor 402 may also provide 1DES/3DES/DVB/Multi2/AES descrambling support. Instead of receiving the demodulated data stream 254 from the modulator/demodulator 302, the transport processor 402 may optionally separates or parses an external data stream 472 into the compressed video component 450 and the compressed audio component 458.

The security interface 464 connects the transport processor 402 to the security processor 420. The security processor 420 enables security features for multimedia applications. These applications may include, but are not limited to, single-purpose conditional-access (CA), multi-purpose copy-protection (CP) for Personal Video Recorder (PVR), and/or digital right management (DRM) for a multimedia gateway system to provide some examples. The security processor 420 may implement various security components required in satellite and cable set-top devices and various CA and CP standards, such as the CP for CableCard™ and secure video processor (SVP) to provide some examples. Those skilled in the art will recognize that the security processor 420 may implement a variety of security algorithms, whether open or proprietary without departing from the spirit and scope of the present invention. The security processor 420 may additionally support, but is not limited to, various security features in an integrated set-top device system on chip (SoC) system such as one-time programmable non-volatile memory (OTP NVM) security module for unique keys and various security features and restrictions to be permanently programmed into a chip, key generation and management to the conditional access descramblers, e.g., DVB, DES descramblers for removing conditional access encryption from incoming transport streams, key generation and management to the memory-to-memory scramblers/descramblers, for PVR copy protection and other applications, protection to keys required by the interface security modules, access control of various interfaces, e.g., REMUX interface, provide a secure environment and hardware acceleration for scrambling and descrambling the external data with algorithm such as DES/3DES, AES, RSA, and DH algorithms, provide a secure environment for generating and verifying digital signatures, e.g., using RSA and DSA, and/or perform external memory data validation, such as verify the signature of the codes stored in the off-chip program memory before the host CPU is authorized to execute these codes to provide some examples.

In this exemplary embodiment, the video decoder 404 may support high-definition AVC, VC-1, and ATSC MPEG-2 streams. The video decoder 404 may additionally support high-definition VC-1 (advanced profile level 3, main, and simple profiles) and ATSC compliant MPEG-2, main profile at the main level. The video decoder 404 includes an AVC/MPEG-2/VC-1 processor to decompress the compressed video component 450. The compressed video component 450 is decoded or decompressed and the resultant is stored back into the memory source 418 in picture (frame or field) buffers in YCrCb 4:2:0 or any other suitable format.

The video processor 406 processes the uncompressed video component 452 to produce a processed video component 454. More specifically, the video processor 406 scales the uncompressed video component 452 in horizontal and vertical directions and either displays the video immediately (in-line) or captures the uncompressed video component 452 to a memory storage unit for later viewing. In an exemplary embodiment, the scaling function of the video processor 406 is optional, and may be needed for displaying digital or analog video. The video processor 406 includes FIR filters for both upscale and downscale. To improve vertical filtering, a vertical mode of operation has been introduced to facilitate anti-flutter filtering and other advanced visual filtering algorithms. The capture of the uncompressed video component 452 to the memory storage unit is used either to minimize peak bandwidth requirements of the memory storage unit or required by the constraints of the compressed video component 450. In general, capturing of the uncompressed video component 452 to the memory storage unit when scaling may reduce the peak the bandwidth requirements when the scale factor is less than 1.0.

The video processor 406 includes a video subsystem incorporating, but is not limited to, AVC/MPEG/VC-1 feeders to handle the YUV4:2:0 data format, graphics feeders to handle the YUV4:2:2 and RGB data formats, video feeders to handle the YUV4:2:2 data formats, video scalers such as 2D scalers, capture blocks to store YUV4:2:2 data formats, or video compositors, combining video and graphics to provide some examples.

The video processor 406 may additionally insert text and graphics into the uncompressed video component 452 using a graphics subsystem. The graphics subsystem includes the compositor 422 for scaling of the uncompressed video component 452, BLT functions, and/or ROP operations to provide some examples. The compositor 422 interacts with the memory storage unit with no real time processing of graphics to reduce the real-time scheduling (RTS) requirements. For example, the video processor 406 may allow for ancillary data, Teletext, close caption, NABTS, WSS, CGMS-A to be inserted into the uncompressed video component 452. More specifically, the video processor 406 allows users to create a series of frame-buffers that allow an unlimited number of graphics layers to be composited and blended together before being displayed. Graphics data can include station logos, chroma-keyer data, or the like, that is superimposed over video from the video decoder 404, and displayed on a television, monitor, PDA, portable computer, enhanced telephone, or the like. Once the graphical frame-buffers are available, they may be combined with the uncompressed video component 452 using a compositor. The compositor allows one video surface to be combined with a graphical surface (frame-buffers). The blending order of any surface is controlled by software to allow the utmost flexibility for the end-user. Once the graphics surfaces are available, they may be switched in for display.

The video encoder 408 is an analog video encoder with Macrovision™ that supports the following output standards: NTSC-M, NTSC-J, PAL-BDGHIN, PAL-M, and PAL-Nc. The video encoder 408 additionally supports the following output formats: composite, S-video, SCART1, SCART2, RGB and YPrPb component. The video encoder 408 additionally supports the following output resolutions: 480i, 576i, and 480p output is also supported (specified use cases).

As shown in FIG. 4B, the video DAC 410 includes up to six 10-bit video DACs to produce an YPrPB output 472.1, RGB outputs 472.2 through 473.4, a CVBS output 472.5, and an S-Video output 472.6. The video DAC 410 may additionally support SCART1 as well as component, S-Video (Y/C), and composite video (CVBS) outputs.

In this exemplary embodiment, the audio decoder 412 may decode AAC-LC (ISO/IEC 13818-7) having an input up to 5.1 channels with one coupling channel (dependent or independent) and up to 288 kbps per channel and an output that is downmixed to two channels with supported sampling rates of 16 kHz, 32 kHz, 44.1 kHz, and 48 kHz to provide some examples. Both ADTS and ADIF formats are supported. The audio decoder 412 may additionally decode AAC-LC+SBR (ISO/IEC 13818-7, 14496-3:2001/AMD, HE-AAC, aacPlus, AAC+, AAC-SBR, AAC-HE) up to 288-Kbps per channel with supported sampling rates of 16 kHz, 32 kHz, 44.1 kHz, and 48 kHz. The audio decoder 412 may further decode AAC+5.1 Level 4, Dolby Digital Plus, Dolby Digital (ATSC-A52/a) having an input may be up to 5.1 channels and an output is downmixed to two channels support all sample rates and all bitrates, MPEG-1 (ISO/IEC-11172-3) Layer 1, 2, 3 (MP3) having an input of 2.0 channels supporting all sample rates and bitrates, WMA, or any other suitable audio format to provide some examples.

Referring back to FIG. 4B, the audio processor 414 may include a Sony/Philips Digital Interface (SPDIF) to additionally produce a SPDIF output 466.3 simultaneously with the processed audio component 462. The SPDIF Generator complies with IEC60958 and IEC61937 and produces the preamble, performs bi-phase encoding, and generates the parity bit for each sub-frame, outputting them at the proper time. The four auxiliary bits, 20 payload bits, and V/U/C bits are controlled by an incorporated micro-sequencer. The micro sequencer also sends a 192-sample block sync indicator.

The audio processor 414 may support monaural audio formats used worldwide including NTSC and most PAL variants as well as supporting BTSC stereo encoding and transmission, including generation of a pilot signal that is locked to the input start-of-line. The audio processor 414 may additionally supports BTSC secondary audio program (SAP) encoding and transmission. The secondary audio program may be transmitted simultaneously with a monaural channel.

In this exemplary embodiment, the audio DAC 416 additionally converts the audio component 462 from PCM data to an analog waveform. The audio DAC module may supports sample rates of, but not limited to, 32 kHz, 44.1 kHz, 48 kHz, and 96 kHz. The output of the audio DAC is a pair of differential pulse density outputs for left channel 466.1 and right channel 466.2. The left channel 466.1 and right channel 466.2 may be low-pass filtered externally to recover the audio signal.

The RF Modulator/BTSC encoder 424 converts the encoded video component 456 and the processed audio component 462 into an analog RF-modulated television signal 468 that is suitable for demodulation by a conventional television demodulator. In an exemplary embodiment, the RF Modulator/BTSC encoder 424 modulates the analog RF-modulated television signal 468 to NTSC Channel 3 (61.25 MHz) or NTSC Channel 4 (67.25 MHz). Those skilled in the art will recognize that the RF Modulator/BTSC encoder 424 may modulate the RF-modulated television signal 468 to any suitable NTSC Channel or suitable carrier frequency without departing from the spirit and scope of the present invention.

The RF Modulator/BTSC encoder 424 may support NTSC and PAL color standards in conjunction with the monochrome television standards B/G, H, I, M, and N. The RF Modulator/BTSC encoder 424 may additional support both monaural and stereo audio operation. More specifically, the RF Modulator/BTSC encoder 424 may support, but is not limited to, the following audio transmission capabilities: MONO mode: Monaural transmission, STEREO mode: BTSC stereo encoding and transmission, SAP mode: BTSC encoding and transmission of SAP (secondary audio program), DUAL MONO: BTSC encoding and transmission of SAP simultaneously with a monaural signal, or any other suitable audio transmission format.

Those skilled in the arts will recognize that the security processor 420, the compositor 422, and the RF Modulator/BTSC encoder 424 may be included within the exemplary embodiment shown in FIG. 4A

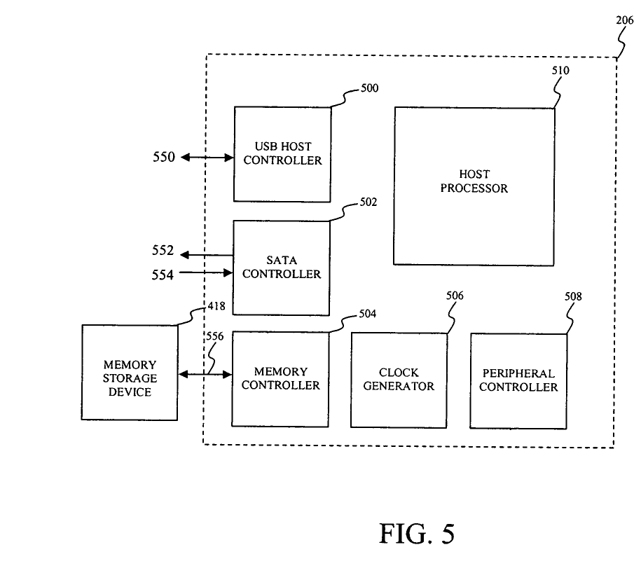

FIG. 5 illustrates a block diagram of a processor according to an embodiment of the present invention. The processor 206 incorporates a complete MIPS®32™-based microprocessor subsystem, including caches with bridging to memory and a local bus. Advanced connectivity features of the processor 206 may include two USB 2.0/1.1 ports, an additional independent USB 1.1 port, a serial ATA port, an Ethernet port with a MAC with an integrated PHY and alternate Media Independent Interface (MII).

As shown in FIG. 5, the processor 206 includes a Universal Serial Bus (USB) Host Controller 500, a Serial Advanced Technology Attachment (SATA) controller 502, a memory controller 504, a clock generator 506, a peripheral controller 508, and a host processor 510.

The USB module 500 couples to one or more USB devices 512. The USB devices may include computer peripherals such as mouse devices, keyboards, joysticks, digital cameras, and printers to provide some examples. The USB module 500 includes a host controller with root hub capability, a device controller, and integrated transceivers. In an exemplary embodiment, the USB module includes at least two integrated transceivers with two ports. In another exemplary embodiment, the host controller is USB 2.0 compliant, and the transceiver is able to operate at a transfer rate of 480 Mbps. The USB module 500 may additionally include a third USB 1.1 host controller independent and private with respect to the USB 2.0 channels.

The SATA controller 502 integrates a serial ATA disk drive control module and physical layer interface for an external serial ATA disk drive. In an exemplary embodiment, the SATA controller 502 includes a SATA 1.0 compliant controller with integrated Physical layers and connects to an 32/64-bit 33/66-MHz (internal bus speed) internal bus bridge. The SATA controller 502 may communicate with any Serial ATA device on the device side, such as an SATA HDD, or a SATA-to-IDE bridge. The SATA controller 502 includes DMA channels to maximize the system throughput.

The memory controller 504 interfaces with the memory storage device 418 using memory interface 556. The memory controller 504 may include a DDR-1/DDR-2 controller. In an exemplary embodiment, the memory controller 504 is implemented as a 32-bit DDR-1/DDR-2 (double-data rate) SDRAM memory controller supporting up to 256 MB of memory. The memory controller 504 may additionally support 32-bit wide DDR for its memory interface. In an exemplary embodiment, the DRAM clock rate is 200 MHz. For DDR2, the clock rate supported is 266 MHz. The memory controller 504 may support other on-chip clock rates, and externally supplied DRAM clocks may also be used. The memory controller 504 may support, but is not limited to the following configurations: 4M×16 resulting in 32 MB, 8M×16 resulting in 64 MB, 16M×16 resulting in 128 MB, or 32M×16 resulting in 256 MB. The size of the memory storage device 418 will depend on the specific application.

The memory controller 504 may additional include a PCI/EBI Interface. The PCI/EBI Interface is a shared interface that supports 33 MHz PCI 2.2 and external buses to allow the internal processor control of external peripherals that may be attached to the PCI bus and to allow an external controller to access the peripherals and memory. In an exemplary embodiment, the PCI/EBI Interface supports 33 MHz PCI 2.2. Both the PCI and the EBI may operate at the same PCI clock input frequency. Critical control signals such as FRAMEb or CSb to provide some examples are not shared. The arbitration and multiplexing of the PCI/EBI interface may occur completely in hardware. When operating as an EBI function, PCI devices may not respond because the FRAMEb is not asserted. When operating as a PCI function, EBI devices may not respond because the CSb is not asserted. In another exemplary embodiment, both EBI and PCI interfaces operate at a max clock frequency of 33 MHz.

Software running on the host processor 510 can allow the cable set-top device 108 to act as a PCI South bridge to allows for an easier migration path for external processors to access peripheral devices, such as a USB controller to provide an example. When operating in PCI Client mode, the EBI function is disabled and the PCI interface supports both internal and external PCI masters. When operating in PCI Host Bridge mode, the EBI interface functions as an EBI bus master only. The PCI interface may additionally support both external and internal PCI masters. The internal PCI arbiter is designed to support the EBI request as a modified PCI master with special request and grant handshaking. If an external PCI arbiter is selected, the special EBI request/grant pair maps to the PCI GNT2b/REQ2b pins. The EBI is an external bus interface intended to support the connection of external memory storage units such as SRAMS, flash memories, and EPROMS to provide some examples and to interface with additional external peripherals.

The clock generator 506 provides the necessary clocking for, but is not limited to, the modulator/demodulator 302, the media access controller (MAC) 304, and/or the processor 306. The clock generator may use an internal or external reference to generate the required clocks.

The peripheral controller 508 provides common peripherals used to control the set-top device 108. In addition, the peripheral controller 508 includes an external bus interface to support connection of external devices like SRAM and flash memories. The peripheral controller 508 may control, but is not limited to an infrared (IR) blaster, a IR keyboard/remote receiver, a universal asynchronous receiver/transmitters (UARTS), a Keypad/LED controller, General Purpose Input/Output (GPIO) pins, a Master SPI controller, a Modified SPI for CableCARD™ support, a master BSC controller, a slave BSC controller, a smart card interfaces, a PWM generator, a programmable timers and/or a watchdog timer.

The host processor 510 incorporates a 400-DMIPS®MIPS®32 CPU with a 32K instruction and 32K data 2-way set-associative caches and a 4 KB 4-way read ahead cache. The host processor 510 communicates with all the internal blocks via a MIPS® internal system bus. The host processor 510 interfaces to external devices via an external bus interface (EBI) running up to 33 MHz. All the initialization, register programmability and system software execution is performed by the host processor 510. In an exemplary embodiment, the MIPS® instruction and data fetches as well as DMA functions occur in bursts. In an exemplary embodiment, the host processor 510 incorporates a Standard MIPS® 32 six-stage pipeline including a multiply-divide unit (MDU). The host processor 510 may additionally include I-cache, D-cache and/or readahead cache at the host processor 510 to prefetch and stage the cache lines ahead of the cache misses. The host processor 510 may also include a cache store buffer that allows the data cache to be continuously accessed and stored. In an exemplary embodiment, the host processor 510 and DOCSIS™ processor 322 may be implemented as a single processor.

### CONCLUSION

While various embodiments of the present invention have been described above, it should be understood that they have been presented by way of example, and not limitation. It will be apparent to persons skilled in the relevant arts that various changes in form and detail may be made therein without departing from the spirit and scope of the invention. Thus the present invention should not be limited by any of the above-described exemplary embodiments, but should be defined only in accordance with the following claims and their equivalents.

What is claimed is:

1. An apparatus for processing information within a communications network, comprising:
a cable front end, configured to receive a downstream data signal including a High Definition Advanced Video Codec (HD AVC) video component and an audio component, to demodulate the downstream data signal to produce a demodulated data stream including the HD AVC video component and the audio component;
a video/audio backend to demultiplex the audio component and the HD AVC video component from the demodulated data stream; and
a processor to provide a control message to the cable front end to select a downstream channel for receiving the downstream data signal.

2. The apparatus of claim 1, wherein the cable front end further comprises:
a modulator/demodulator to downconvert the downstream data signal to produce a demodulated data stream.

3. The apparatus of claim 2, wherein the modulator/demodulator comprises:
a programmable gain amplifier (PGA) and an analog to digital (A/D) converter to amplify and digitize the downstream data signal.

4. The apparatus of claim 1, wherein the cable front end further comprises:
a modulator/demodulator to upconvert a digital signal to produce a upstream data signal.

5. The apparatus of claim 4, wherein the cable front end further comprises:
a media access controller (MAC) to generate the digital signal.

6. The apparatus of claim 5, wherein the MAC is DOCSIS™ compliant.

7. The apparatus of claim 1, wherein the video/audio backend comprises:
a transport processor to parse the HD AVC video component and the audio component from the demodulated data stream.

8. The apparatus of claim 7, wherein the video/audio backend comprises:
a video decoder to decode the HD AVC video component to produce an uncompressed HD AVC video component;
a video processor to insert text or graphics into the uncompressed HD AVC video component to produce a processed video component;
a video encoder to encode the processed HD AVC video component into an along video standard to produce an encoded HD AVC video component; and
a video digital to analog (D/A) converter to convert the encoded HD AVC video component from a digital representation to an analog representation.

9. The apparatus of claim 8, wherein the video encoder encodes the processed HD AVC video component according to at least of one NTSC, PAL, 480i, 480p, or 576i.

10. The apparatus of claim 7, wherein the video/audio backend comprises:
an audio decoder to decode the audio component to produce a uncompressed audio component;
an audio processor to insert sound effects in the uncompressed audio component to produce a processed audio component; and
an audio digital to analog (D/A) to convert the processed audio component from a digital representation to an analog representation.

11. The apparatus of claim 10, wherein the audio component is Pulse Code Modulated (PCM).

12. The apparatus of claim 1, wherein the processor further comprises:
Serial Advanced Technology Attachment (SATA) controller to interface an external serial ATA disk drive.

13. The apparatus of claim 1, wherein the processor further comprises:
a USB module to control one or more external USB devices.

14. The apparatus of claim 1, wherein the processor further comprises:
a memory controller to interface with a memory storage device.

15. The apparatus of claim 14, wherein memory storage device is a DDR memory.

16. An apparatus for processing information within a communications network, comprising:
a cable front end, configured to receive a downstream data signal including a High Definition Advanced Video Codec (HD AVC) video component and an audio component, to demodulate the downstream data signal to produce a demodulated data stream including the HD AVC video component and the audio component;
a transport processor to parse the HD AVC video component and the audio component from the demodulated data stream;
a video decoder to decode the HD AVC video component to produce an uncompressed HD AVC video component;
a video processor to insert text or graphics into the uncompressed HD AVC video component to produce a processed video component;
a video encoder to encode the processed HD AVC video component into an along video standard to produce an encoded HD AVC video component; and
a video digital to analog (D/A) converter to convert the encoded HD AVC video component from a digital representation to an analog representation.

17. The apparatus of claim 16, wherein the cable front end further comprises:
a modulator/demodulator to downconvert the downstream data signal to produce a demodulated data stream.

18. The apparatus of claim 17, wherein the modulator/demodulator comprises:
a programmable gain amplifier (PGA) and an analog to digital (A/D) converter to amplify and digitize the downstream data signal.

19. The apparatus of claim 16, wherein the cable front end further comprises:
a modulator/demodulator to upconvert a digital signal to produce a upstream data signal.

20. The apparatus of claim 19, wherein the cable front end further comprises:
a media access controller (MAC) to generate the digital signal.

21. The apparatus of claim 20, wherein the MAC is DOCSIS™ compliant.
